(19) United States
(12) Patent Application Publication
(10) Pub. No.: US 2010/0306243 A1
(43) Pub. Date: Dec. 2, 2010

(54) ELECTRONIC DEVICE FOR DISPLAYING SHORTCUT KEYS AND METHOD THEREOF

(75) Inventor: WEI-FENG SUN, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/507,809

(22) Filed: Jul. 23, 2009

(30) Foreign Application Priority Data
Jun. 1, 2009 (CN) 200910302814.X

(51) Int. Cl. G06F 7/06; G06F 17/30

(52) U.S. Cl. 707/769; 707/704; 707/759; 707/812

(57) ABSTRACT

An electronic device for displaying shortcut keys, comprising: a storage unit; a first display unit; a second display unit; and a CPU (central processing unit) comprising: a detecting module configured for detecting whether there is an running application, and displaying the running application on the first display unit; a shortcut key acquiring module configured for acquiring a setting information of shortcut keys and storing the acquired setting information of the shortcut keys in the storage unit if there is an running application; and a display module configured for displaying the acquired setting information of the shortcut keys on the second display unit.

### BACKGROUND

1. Technical Field

The present disclosure relates to an electronic device for displaying shortcut keys and a method thereof.

2. Description of Related Art

In general, many electronic devices have shortcut keys which are set for user to operate the electronic devices easily. However, functions of the same shortcut keys may be different in different applications. So, when using one application, the user must be familiar with the function of the shortcut keys to make an easier use of the application. It is, however, time-consuming for a user to remember the functions of the of shortcut keys in different applications run by an electronic device.

Therefore, what is needed is an electronic device which can display shortcut keys and a method for such a device.

### BRIEF DESCRIPTION OF THE DRAWINGS

FIG. 1 is a block diagram of the hardware infrastructure of an electronic device configured for displaying shortcut keys in accordance with an exemplary embodiment.

FIG. 2 is another block diagram of the hardware infrastructure of the electronic device configured for displaying shortcut keys in accordance with an exemplary embodiment.

FIG. 3 is a schematic diagram of a second display unit of a keyboard in accordance with an exemplary embodiment.

FIG. 4 is a schematic diagram of the second display unit set in a first display unit in accordance with an exemplary embodiment.

FIG. 5 is a schematic diagram of setting information of shortcut keys of an application displayed on the second display unit in accordance with an exemplary embodiment.

FIG. 6 is a flowchart of a displaying shortcut keys method implemented by the electronic devices of FIGS. 1 and 2, in accordance with an exemplary embodiment.

### DETAILED DESCRIPTION

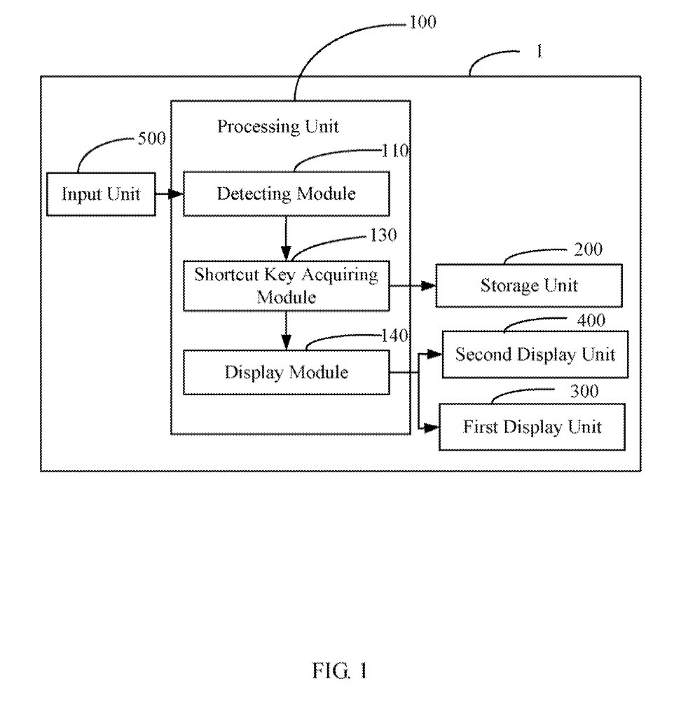

FIG. 1 is a block diagram of the hardware infrastructure of an electronic device 1 configured for displaying shortcut keys in accordance with an exemplary embodiment. The electronic device 1 includes a processing unit 100, a first display unit 300, a second display unit 400, an input unit 500, and a storage unit 200. The input unit 500 is configured to receive a user operation. The processing unit 100 includes a detecting module 110, a shortcut key acquiring module 130, and a display module 140.

The detecting module 110 is configured to detect whether there is a running application, and display the running application on the first display unit 300.

The shortcut key acquiring module 130 is configured to acquire setting information of shortcut keys for the running application and store the acquired setting information in the storage unit 200 when the application is started to run.

The display module 140 is configured to display the acquired setting information of the shortcut keys on the second display unit 400. For better understanding the second display unit 400, detailed description is given in the following.

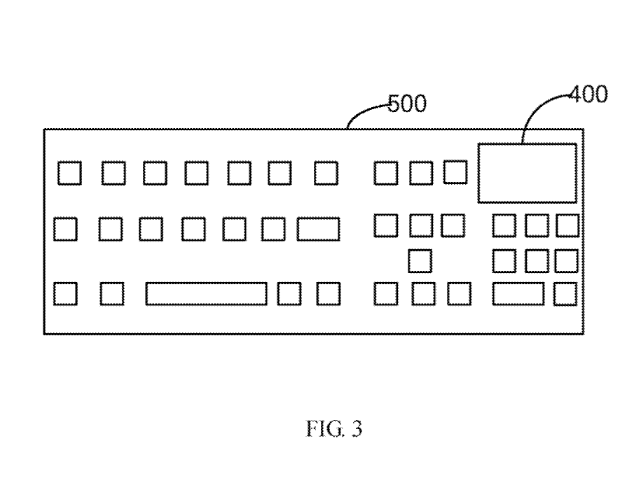

Referring to FIG. 3, the second display unit 400 may be set in the input unit 500. In the exemplary embodiment, the input unit 500 is a keyboard. If there is a plurality of running applications, the display unit 140 displays the new acquired setting information of the shortcut keys on the second display unit 400, and overlays the current display content of the second display unit 400.

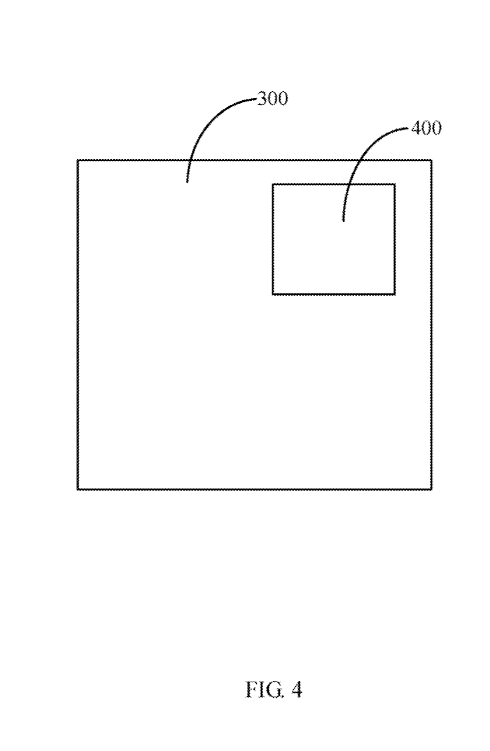

Referring to FIG. 4, the second display unit 400 may be a small window of the first display unit 300. The display module 140 displays the acquired setting information of the shortcut keys in the small window.

In a first embodiment, the shortcut key acquiring module 130 directly acquires the setting information of the shortcut keys from the running application.

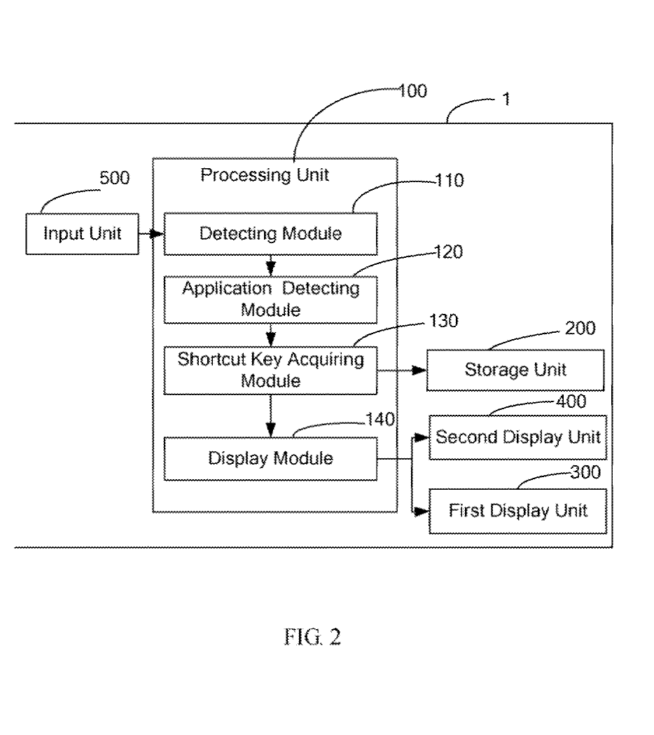

Referring to FIG. 2, in a second embodiment, the electronic device 1 further includes an application detecting module 120. The application detecting module 120 detects whether an application is running in the device 100. If an application is running, the shortcut key acquiring module 130 acquires the setting information of the shortcut keys for the application from the storage unit 200; if the application is started to run initially, the shortcut key acquiring module 130 directly acquires the setting information of the shortcut keys from the application.

The application detecting module 120 is further configured to detect whether one of more running applications is operated again. If one of more running applications is operated again, the display module 140 displays the operated application on the first display unit 300 again to overlay current display content of the first display unit 300, acquires the setting information of the shortcut keys corresponding to the operated application, and displays the setting information on the second display unit 400 to overlay the current display content of the second display unit 400.

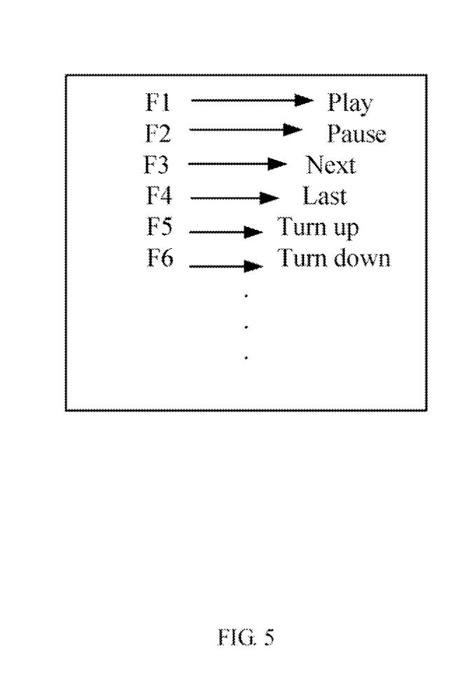

FIG. 5 is a schematic diagram of setting information of shortcut keys of an application displayed on the second display unit in accordance with an exemplary embodiment. The current running application is a music player, the setting information of the shortcut keys may be: pressing F1 to play a song, pressing F2 to pause the song, and so on.

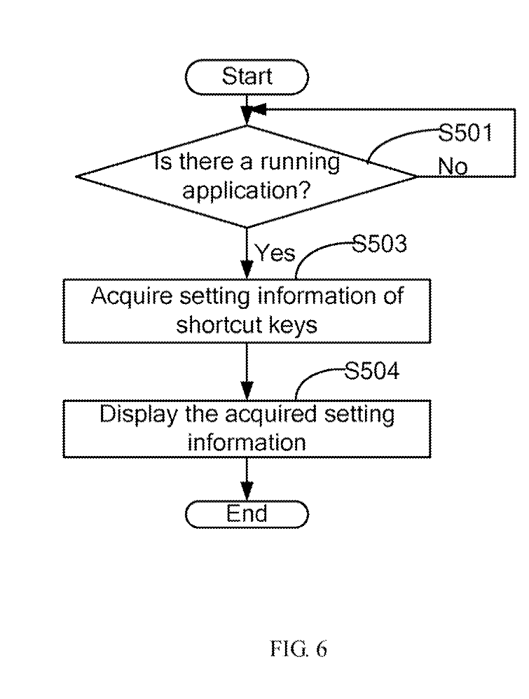

FIG. 6 is a flowchart of a displaying shortcut keys method implemented by the electronic device of FIG. 1 in accordance with an exemplary embodiment.

In step S501, the detecting module 10 detects whether there is an running application, and displays the running application on the first display unit 300.

In step S503, the shortcut keys acquiring module 130 acquires the setting information of the shortcut keys if there is an running application.

In step S504, the display module 140 displays the acquired setting information of the shortcut keys on the second display unit 400.

In the first embodiment, In step S502, the shortcut key acquiring module 130 directly acquires the setting information of the shortcut keys from the running application.

In the second embodiment, In step S502, when there is an running application, the application detecting module 120 detects whether the running application has been already run by the electronic device 1.

If the running application has been already run by the electronic device 1, the shortcut key acquiring module 130 acquires the setting information of the shortcut keys from the storage unit 200; if the running application is just started to run by the electronic device 1, the shortcut key acquiring module 130 directly acquires the setting information of the shortcut keys from the running application.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device for displaying shortcut keys, comprising:
a storage unit;
a first display unit;
a second display unit; and
a CPU (central processing unit) comprising:
a detecting module configured for detecting whether there is an running application, and displaying the running application on the first display unit;
a shortcut key acquiring module configured for acquiring a setting information of shortcut keys and storing the acquired setting information of the shortcut keys in the storage unit if there is an running application; and
a display module configured for displaying the acquired setting information of the shortcut keys on the second display unit.

2. The electronic device as claim 1, wherein the shortcut key acquiring module is configured for directly acquiring the setting information of the shortcut keys from the running application.

3. The electronic device as claim 1, wherein the CPU further comprises a application detecting module which is configured for detecting whether the running application has been already run by the electronic device;
if the running application is just started to run by the electronic device, the shortcut key acquiring module directly acquires the setting information of the shortcut keys from the running application; and
if the running application has been already run by the electronic device, the shortcut key acquiring module acquires the setting information of the shortcut keys from the storage unit.

4. The electronic device as claim 3, wherein the application detecting module is further configured for detecting whether one of more running application is operated again, if one of more running applications is operated again, the display module displays the operated application on the first display unit again to overlay the current display content of the first display unit, acquires the setting information of the shortcut keys corresponding to the operated application, and displays the setting information on the second display unit to overlay the current display content of the second display unit.

5. The electronic device as claim 1, wherein the electronic device further comprises an input unit, the second display unit is set on the input unit.

6. A displaying shortcut keys method implemented by an electronic device which comprises a storage unit, a first display unit, and a second display unit, the method comprising:
detecting whether there is an running application of the electronic device, and displaying the running application on the first display unit;
acquiring a setting information of shortcut keys and storing the acquired setting information in the storage unit if there is an running application;
displaying the acquired setting information on the second display unit.

7. The method as claim 6, wherein the acquiring setting information step comprises: directly acquiring the setting information of the shortcut keys from the running application.

8. The method as claim 6, wherein the acquiring setting information step further comprises:
detecting whether the running application has been already run by the electronic device;
directly acquiring the setting information of the shortcut keys from the running application if the running application is just started to run by the electronic device;
acquiring the setting information of the shortcut keys from the storage unit if the running application has been run by the electronic device.

9. The method as claim 8, further comprising:
detecting whether one of more running application is operated again;
if one of more running applications is operated again, displaying the operated application on the first display unit again to overlay the current display content of the first display unit, acquiring the setting information of the shortcut keys corresponding to the operated application, and displaying the setting information on the second display unit to overlay the current display content of the second display unit.

10. The method as claim 6, further comprising:
displaying the setting information of the shortcut keys of the new running application on the second display unit to overlay the current content of the second display unit.
